(19) United States
(12) Patent Application Publication
(10) Pub. No.: US 2021/0241362 A1
(43) Pub. Date: Aug. 5, 2021

(54) SYSTEM AND METHOD FOR AUGMENTED REALITY-ENABLED GIFT CARDS USING AN ARTIFICIAL INTELLIGENCE-BASED PRODUCT DATABASE

(71) Applicant: AR QUEUE, INC., San Rafael, CA (US)

(72) Inventor: Du NGUYEN, San Rafael, CA (US)

(21) Appl. No.: 17/073,245

(22) Filed: Oct. 16, 2020

Related U.S. Application Data
(60) Provisional application No. 62/916,117, filed on Oct. 16, 2019.

(51) Int. Cl. G06Q 30/06; G06T 7/70; G01S 19/01

(52) U.S. Cl. CPC G06Q 30/0643; G06Q 30/0635; G06K 9/00671; G01S 19/01; G06T 7/70

(57) ABSTRACT

A system comprises a database configured to store product data associated with a plurality of retailers, retail locations, and augmented reality experiences related to the product data; at least one hardware processor coupled with the database; and more software modules that are configured to, when executed by the at least one hardware processor, receive a purchase of a gift card from a first user, wherein the purchase specifies a second user to receive the gift card, a retailer, retailer location(s), gift card value, and augmented reality experience, receive a personalized message for the second user, from the first user, to be associated with the gift card, send a notification to the second user with instructions for retrieving the gift card at the specified retail location, receive location information from the second user, verify the location information.

### BACKGROUND

### 1. Field of the Invention

This disclosure relates to augmented reality (AR) and related systems. More specifically, this disclosure relates to systems and methods for in-store AR experiences using a mobile wireless device.

### 2. Related Art

Retail store or other shopping experiences can be limited by what you see on the shelf and what you can discern from a small tag or sign accompanying the products. Thus, there are few ways to determine additional information about a product apart from what a shopper sees first hand.

### SUMMARY

One aspect of the disclosure provides a system and method for providing incentives in a retail location using an augmented reality (AR) system. The method can include storing product data associated with a plurality of products, each product of the plurality of products being associated with a unique identifier. The method can include receiving first images from a first mobile device, the first images capturing portions of a first product of the plurality of products and a first unique identifier associated with the first product. The method can include receiving second images from a second mobile device, the second images capturing portions of a second product of the plurality of products and a second unique identifier associated with the second product. The method can include storing the first images and the second images with product data associated with a respective first product and second product (training data). The method can include receiving a captured image related to a portion of the first product from a third mobile device, the captured image including at least a portion of the first product. The method can include transmitting product data associated with the first product to the third mobile device based on the captured image.

According to one aspect, a system comprises a database configured to store product data associated with a plurality of retailers, and retail locations, and augmented reality experiences related to the product data; at least one hardware processor coupled with the database; and one or more software modules that are configured to, when executed by the at least one hardware processor, receive a purchase of a gift card from a first user, wherein the purchase specifies a second user to receive the gift card, a retailer, retailer location(s), gift card value, and augmented reality experience, receive a personalized message for the second user, from the first user, to be associated with the gift card, send a notification to the second user with instructions for retrieving the gift card at the specified retail location, receive location information from the second user, verify the location information, present the augmented reality experience to the second user, and present the gift card to the second user for redemption once the augmented reality experience is complete.

Other features and advantages will be apparent to one of ordinary skill with a review of the following disclosure.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

is a graphical depiction of a system for augmented reality shopping;

FIG. 3 is a graphical representation of a portion of the system of FIG. 1;

FIG. 4 is a graphical representation of captured images stored at the server of FIG. 1;

FIG. 5 is a graphical depiction of a virtual shopping companion for use with the system of FIG. 1, FIG. 2, and FIG. 3;

FIG. 6 is a functional block diagram illustrating an example wired or wireless system 100 for use with the system of FIG. 1, FIG. 2, FIG. 3, and FIG. 4;

FIG. 7 is a flowchart of an embodiment of a method for augmented reality shopping performed by the system of FIG. 1; and

FIG. 8 is a flowchart of another embodiment of a method for augmented reality shopping performed by the system of FIG. 1.

### DETAILED DESCRIPTION

This disclosure is related to AR devices that can provide additional information to consumers that help retailers drive foot traffic.

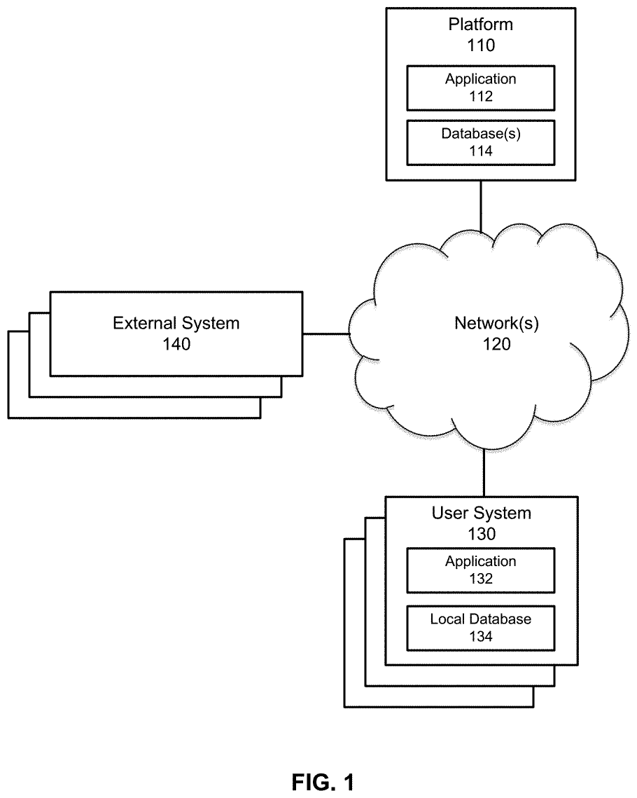

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, Automated Teller Machines, and/or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132 executing on one or more user system(s) 130 may interact with a server application 112 executing on platform 110 to execute one or more or a portion of one or more of the various functions, processes, methods, and/or software modules described herein. Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules that implement one or more of the processes, methods, or functions of the application described herein.

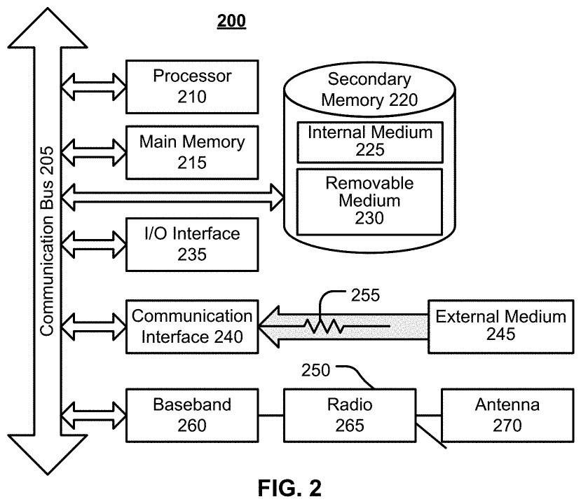

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the application or one or more software modules of the application) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors, such as processor 210. Additional processors may be provided, such as an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, the Pentium® processor, Core i7® processor, and Xeon® processor, all of which are available from Intel Corporation of Santa Clara, Calif.

Processor 210 is preferably connected to a communication bus 205.

Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Secondary memory 220 is a non-transitory computer-readable medium having computer-executable code (e.g., disclosed software modules) and/or other data stored thereon. The computer software or data stored on secondary memory 220 is read into main memory 215 for execution by processor 210.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240.

Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed application, or software modules) is stored in main memory 215 and/or secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor 210, which may be a central processing unit (CPU). Processor 210 has access to data storage areas 215 and 220. Processor 210 is preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments.

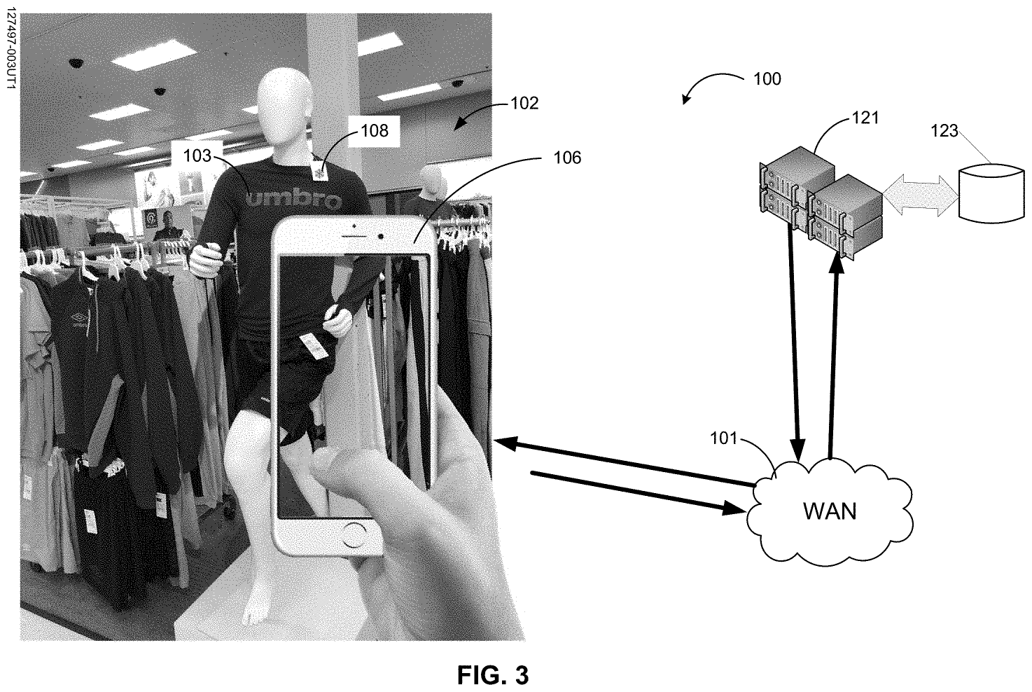

FIG. 3 is a graphical depiction of a system for augmented reality shopping. A system 100 can be implemented in a retail store 102. A user can view the store 102 and one or more products 103 via an AR display on an AR-enabled mobile device 106. The mobile device 106 can display the physical world as captured by an onboard camera, in addition to product information and other data superimposed on the physical world by the display of the mobile device 106. As used herein, the mobile device 106 can include, for example, portable or wireless electronic devices, including smartphones, tablet PC's, AR-enabled glasses or headsets (e.g., Computer Vision) and the like. This list is exemplary and not intended to be exhaustive.

The retail store 102 can have a plurality of products 103. The store 102 is used as a primary example, however the store 102 can represent any location, whether or not retail services are performed. Only one exemplary product 103 is labeled for brevity. The product is depicted as an UMBRO® men's long sleeve logo t-shirt. Any product can be implemented or used with the system 100. The product 103 can be associated with a unique identifier 108. The unique identifier 108 can coupled to the product 103 on, for example, a tag (e.g., as shown) including the unique identifier 108 for the product 103. The unique identifier 108 can be, for example, a QR code, or other image, character, or design (e.g., a snowflake as shown) that can be paired with the product 103 and later be used to identify the product 103.

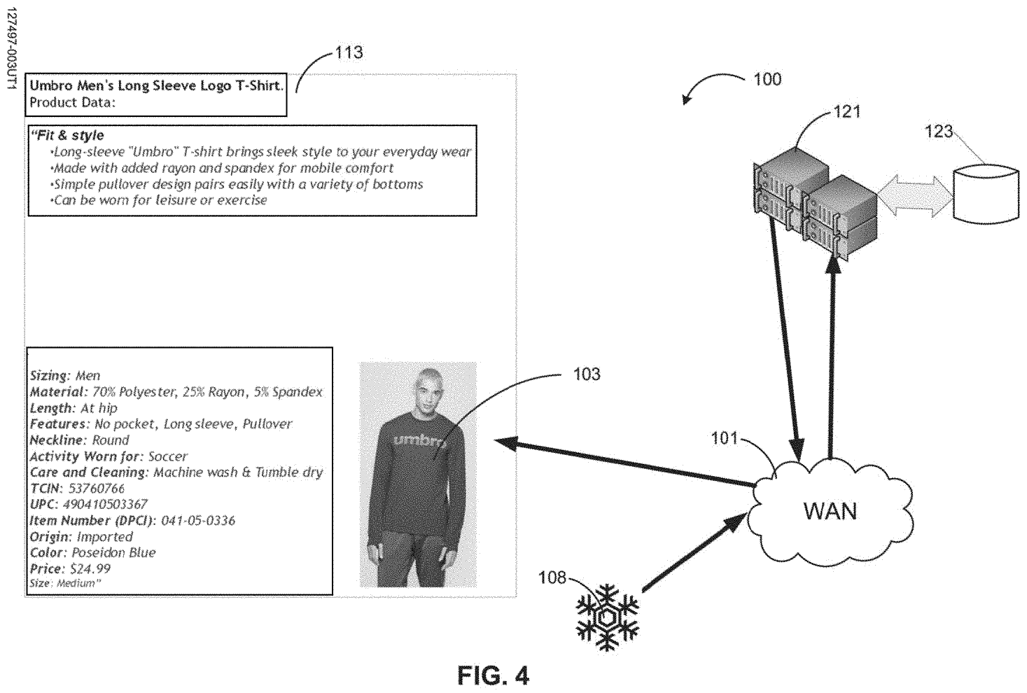

The system can have one or more servers 121. The server 121 can be coupled to a wide area network (WAN) 101 such as the Internet. The server 121 can have one or more memories for storing information and can be coupled with one or more databases 123. For example, the server 121 can store information about the product 103 in memory or database(s) 123. The information can include sizing, fit, materials, among many other details. This aspect is further described below in connection with FIG. 4. The server 121 can include large amounts of data related to the identification of the product 103. For example, machine learning (ML) and artificial intelligence (AI) can be implemented to store vast quantities of data associated with images of a plurality of products 103 or parts of the product(s) 103 from different angles. The unique identifier 108 can be stored by the server 121 in association with the product information. The server 121 can store the data with the identifier 108 and the identity of the product 103 via one or more ML training programs, for example. The mobile device 106 can also provide location (e.g., GPS location data of the mobile device 106) to the server 121.

FIG. 4 is a graphical representation of a portion of the system 100 of FIG. 3. When the device 106 transmits the captured image back to the server 121, the information returned can include product data 113. The product data 113 stored by the server 121 shown in FIG. 4 are exemplary details related to the product 103, including manufacturer, sizing, material, dimensions, specific features, related activity, care and cleaning information, specific item or product information such as a UPC or SKU, price, size, and origin, among various other details. The foregoing list of exemplary details is not intended to be exhaustive and other details may be included. The product data 113 can be received and displayed at, for example, the mobile device 106. Thus, product data 113 in FIG. 4 is illustrative of what would be displayed on the User Interface (U/I) of a user's mobile device, such as a smartphone or tablet.

In some embodiments, the mobile device 106 can capture images and video of the product 103, portions of the product 103, the unique identifier 108, and/or of the store 102. The mobile device 106 can transmit the captured images and video to the server 121 via the WAN 101. The server 121 can store the captured images and create a database including the product data 113 associated with a given product 103 and the captured images. ML algorithms or AI processes can recognize images of portions of the product 103 associated with the unique identifier or with the product 103.

In some embodiments, as images or video of the product 103 are captured by the mobile device 106, the server 121 can also return the product data 113 related to the product 103 as needed, based on the captured images and possibly a query transmitted from the mobile device 106. The product data 113 can be displayed via the mobile device 106 as, for example, an AR overlay of the actual product 103 in the physical world.

In some implementations, the product 103 and the unique identifier 108 can also represent an object in the store 102. For example, other objects, signs, posters, advertisements, etc., can trigger the display of certain media (e.g., video, images, information) via the mobile device 106. As the mobile device 106 captures an image of a given object, the server 121 can transmit, and the mobile device 106 can display, such additional media.

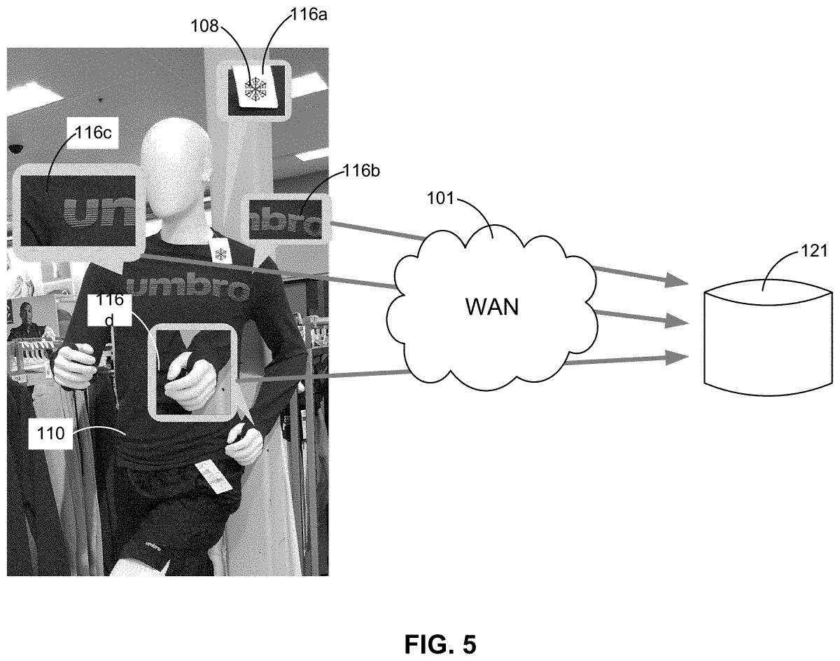

FIG. 5 is a graphical representation of captured images of the product of FIG. 1. A user can enter the store 102 with the wireless mobile device 106. The user can capture an image of at least a portion of the product 103 or the unique identifier 108 coupled to the product 103. The device 106 can then store captured images 116a-d for transmission to and storage by the server 121. Four exemplary captured images 116a-d are shown, labeled 116a, 116b, 116c, 116d. Over time, the captured images 116a-d can be grouped together by individual products (e.g., the product 103) and used to form a training data set. Over time, such a database of images 116a-d can be used to determine what product 103 a user is reviewing (e.g., at the store 102) and provide the product data 113 accordingly. The mobile device 106 can transmit the captured images 116a-d back to the server 121 to train AI-based processes and algorithms to improve future product recognition.

The mobile device 106 can also transmit the captured images 116 to the server 121 to retrieve the product data 113 about the product 103. The system 100 can then identify the product 103 based on the identifier 108 or by an image of a portion of the product 103 (e.g., via a camera on the device 106). In some examples, the mobile device 106 can be set to continuously capture images or video via an AR app associated with the system 100, for example. Using the mobile device 106 and/or such an app, the user can view the product data 113 on the mobile device simply by placing a portion of the product 103 in the display or camera frame of the mobile device 106.

In some embodiments, the captured images 116a-d of at least a portion of the product 103 or the unique identifier 108 can provide access to other details including incentives such as time-sensitive or location-based deals to shoppers (e.g., the user). The system 100 can store or save (e.g., by the server 121) images of the unique identifier 108 along with other contextual features of the image to enable ML processes. For example, training data for the AI/ML system can include images of the identifier 108 first, but over time, as more and more images of the product 103 are collected, the system can implement AI to distinguish the product 103 from a captured image of only a portion of the product 103.

In some implementations, the captured images 116a-d can also include images of full retail displays, departments within the store 102, or areas of a given physical location, such as locations within the retail store 102. The captured images 116a-d can be paired with location information included with the captured images 116a-d or transmitted independently from the mobile device 106. The location data can then be used (e.g., by the system, the server, or the device described and illustrated with respect to FIGS. 1 and 2) to map physical locations within the store 102. Thus, the captured images 116a-d can further provide a tool for mapping various indoor spaces by, for example and crowd sourcing captured images and location data. Such a map can be formed by stitching adjacent images together to form a three dimensional model of the interior of the store 102, a plurality of products 103, and their respective locations within the store 102.

In other implementations, storing images of the store 102 can occur whenever a consumer/user is using the mobile device 106 (e.g., an app operating on the mobile device 106). In some examples, the in-store mapping function can occur independently of the product recognition functions described herein.

The mobile device 106 can further capture (at least a portion of) the product 103, an advertisement, poster, or other object within the store to trigger display of certain media (e.g., AR media) via the display of the mobile device 106. For example, in addition to the product data 113, the mobile device 106 can display videos, pictures, advertisements, and the like when a specified object (e.g., the product 103) enters the viewfinder of the mobile device 106. In one example, the mobile device 106 may capture a poster which the mobile device 106 and server 121 recognize (similar to the product 103), and in response the mobile device 106 displays a specified video, commercial, or special offer; for example, a poster comes to life to display a video in the AR display.

The system 100 can therefore provide retailers the ability to base various product or event promotions to drive foot traffic to specific physical locations, including retail locations, public spaces, offices, etc. by providing users with various incentives via their mobile devices (e.g., the mobile device 106). Retailers can identify patterns in user behavior and shopping habits and tailor offers or incentives to the user based on location of the mobile device 106, images received from the mobile device 106, and the like. In some examples, offers or incentives may appear (e.g., via the mobile device 106) when a user views a specific product 103 or certain items or images via their mobile devices 106. Such offers or incentives can also be triggered when the user enters a specific department with the mobile device 106.

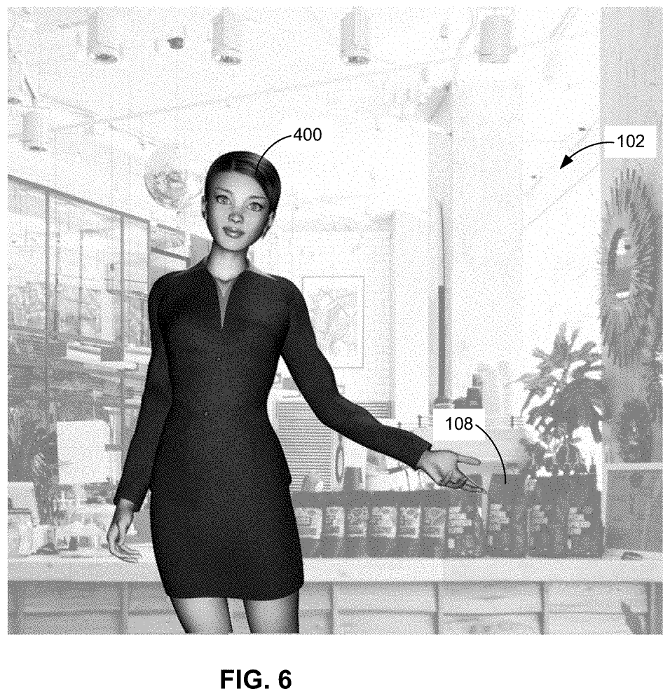

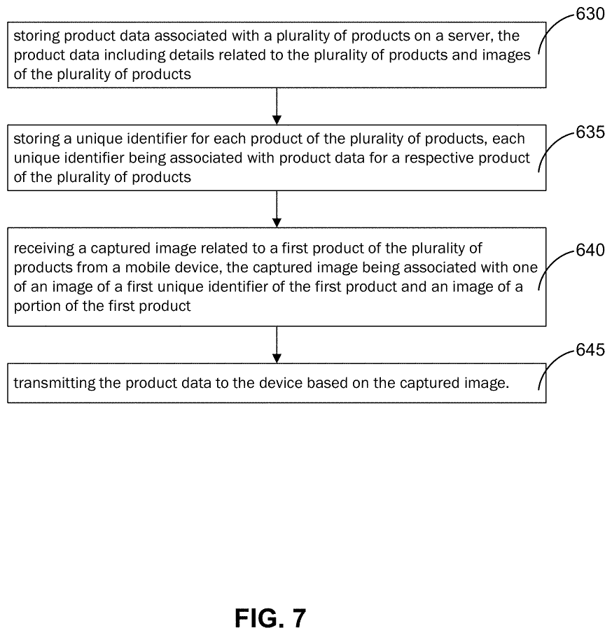

FIG. 6 is a flowchart of an embodiment of a method for augmented reality shopping performed by the system 100 of FIG. 3. The system 100, can implement one or more methods for providing incentives in a retail location using an augmented reality (AR). For example an implementation of such a method can include the steps of FIG. 7.

At block 630, the system 100 can store product data associated with a plurality of products on a server, the product data including details related to the plurality of products and images of the plurality of products.

At block 635, the system 100 can store a unique identifier 108 for each product of the plurality of products, each unique identifier being associated with product data for a respective product of the plurality of products;

At block 640, the system 100 can receive a captured image related to a first product of the plurality of products from a mobile device, the captured image being associated with one of an image of a first unique identifier of the first product and an image of a portion of the first product.

At block 645, the system 100 can transmit the product data to the device based on the captured image.

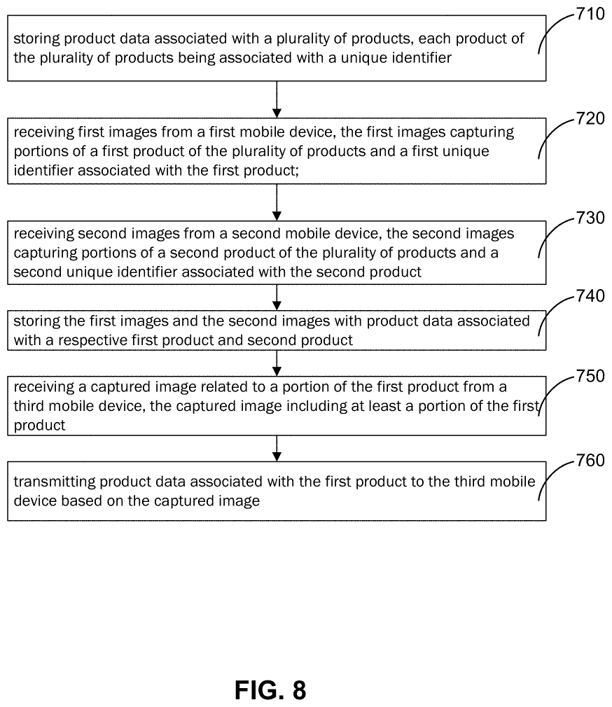

FIG. 8 is a flowchart of another embodiment of a method for augmented reality shopping performed by the system of FIG. 1. The system 100 can implement one or more methods for providing incentives in a retail location using an augmented reality (AR). For example another implementation of such a method can include the steps of FIG. 8.

At block 710, the system 100 can store product data associated with a plurality of products, each product of the plurality of products being associated with a unique identifier;

At block 720, the system 100 can receive first images from a first mobile device, the first images capturing portions of a first product of the plurality of products and a first unique identifier associated with the first product;

At block 730, the system 100 can receive second images from a second mobile device, the second images capturing portions of a second product of the plurality of products and a second unique identifier associated with the second product;

At block 740, the system 100 can store the first images and the second images with product data associated with a respective first product and second product (training data);

At block 750, the system 100 can receive a captured image related to a portion of the first product from a third mobile device, the captured image including at least a portion of the first product; and

At block 760, the system 100 can receive transmit product data associated with the first product to the third mobile device based on the captured image.

In certain embodiments, the systems described above can be used for interactive gift cards that provide personalized experiences for the gift card recipient as illustrated in FIG. 9. As illustrated in step 902, a first user, using, e.g., an application or web interface can purchase a gift card for a second user and for a particular retailer and/or location. When purchasing the gift card, the first user can select via the user interface presented via the, e.g., application or web interface, the retailer, the location, the amount or gift card value, and a particular experience, e.g., AR presentation. The digital gift card can also include a personalized message such as a text, audio, video, hologram or other digital message. The first user can also supply to contact information for the second user.

As illustrated in step 904, the second user can then receive a notification with instructions on how to retrieve the gift card, e.g., the retailer and the location.

As illustrated in step 906, the user then goes to the location, which can be confirmed via GPS or other location data related to the user's device. Alternatively, computer vision in conjunction with a camera included in the second user's device can be user to verify location.

Once there, the AR experience can be initiated in step 908. This may include the second user viewing certain products and information related thereto. The experience may require the user to go to various location within the store, e.g., to retrieve the product information, etc. Once the second user completes the experience the gift card can be displayed to them and is capable of being redeemed as noted in step 910.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. In addition, one embodiment is not necessarily mutually exclusive of another embodiment. Embodiments described herein can be freely combined with one another where combinations of features would not render other feature inoperable for their intended purpose. Thus, the particular features, structures, or characteristics may be combined in any suitable manner in one or more embodiments.

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. A method comprising using at least one hardware processor to:
receive a purchase of a gift card from a first user, wherein the purchase specifies a second user to receive the gift card, a retailer, retailer location(s), gift card value, and augmented reality experience,
receive a personalized message for the second user, from the first user, to be associated with the gift card,
send a notification to the second user with instructions for retrieving the gift card at the specified retail location,
receive location information from the second user,
verify the location information,
present the augmented reality experience to the second user, and
present the gift card to the second user for redemption once the augmented reality experience is complete.

2. The method of claim 1, wherein the location information comprises at least one of GPS information or video or images of the location, and wherein the at least one hardware processor is further configured to, when the location information includes images or videos, to use computer vision algorithms to verify the location information.

3. The method of claim 1, wherein at least one hardware processor is further configured to charge the first user for the gift card amount wither when the augmented reality experience is launched or when the gift card is redeemed.

4. The system of claim 2, wherein the personalized message comprises at least one of a personalized text, audio, video, or hologram/3D message.

5. A system comprising:
a database configured to store product data associated with a plurality of retailers, and retail locations, and augmented reality experiences related to the product data;
at least one hardware processor coupled with the database; and
one or more software modules that are configured to, when executed by the at least one hardware processor,
receive a purchase of a gift card from a first user, wherein the purchase specifies a second user to receive the gift card, a retailer, retailer location(s), gift card value, and augmented reality experience,
receive a personalized message for the second user, from the first user, to be associated with the gift card,
send a notification to the second user with instructions for retrieving the gift card at the specified retail location,
receive location information from the second user,
verify the location information,
present the augmented reality experience to the second user, and
present the gift card to the second user for redemption once the augmented reality experience is complete.

6. The system of claim 5, wherein the location information comprises at least one of GPS information or video or images of the location, and wherein the one or more software modules that are further configured to, when executed by the at least one hardware processor and when the location information includes images or videos to use computer vision algorithms to verify the location information.

7. The system of claim 5, wherein one or more software modules that are further configured to, when executed by the at least one hardware processor to charge the first user for the gift card amount wither when the augmented reality experience is launched or when the gift card is redeemed.

8. The system of claim 5, wherein the personalized message comprises at least one of a personalized text, audio, video, or hologram/3D message.

9. A non-transitory computer-readable medium having instructions stored therein, wherein the instructions, when executed by a processor, cause the processor to:
receive a purchase of a gift card from a first user, wherein the purchase specifies a second user to receive the gift card, a retailer, retailer location(s), gift card value, and augmented reality experience,
receive a personalized message for the second user, from the first user, to be associated with the gift card,
send a notification to the second user with instructions for retrieving the gift card at the specified retail location,
receive location information from the second user,
verify the location information,
present the augmented reality experience to the second user, and
present the gift card to the second user for redemption once the augmented reality experience is complete.

10. The system of claim 9, wherein the location information comprises at least one of GPS information or video or images of the location, and the instructions, when executed by a processor, and when the location information includes images or videos, further cause the processor to use computer vision algorithms to verify the location information.

11. The system of claim 9, wherein the instructions, when executed by a processor, further cause the processor to charge the first user for the gift card amount wither when the augmented reality experience is launched or when the gift card is redeemed.

12. The system of claim 9, wherein the personalized message comprises at least one of a personalized text, audio, video, or hologram/3D message.
